(19) United States
(12) Patent Application Publication
(10) Pub. No.: US 2025/0284240 A1
(43) Pub. Date: Sep. 11, 2025

(54) SHEET CONVEYING DEVICE, IMAGE FORMING APPARATUS, AND SHEET PROCESSING APPARATUS

(71) Applicants: Haruyuki HONDA, Kanagawa (JP); Yuusuke FURUICHI, Kanagawa (JP)

(72) Inventors: Haruyuki HONDA, Kanagawa (JP); Yuusuke FURUICHI, Kanagawa (JP)

(73) Assignee: Ricoh Company, Ltd., Tokyo (JP)

(21) Appl. No.: 18/982,271

(22) Filed: Dec. 16, 2024

(30) Foreign Application Priority Data
Mar. 8, 2024 (JP) 2024-036040

(51) Int. Cl. G03G 21/16; G03G 15/00; G03G 15/20

(52) U.S. Cl. CPC G03G 21/1638; G03G 15/2064; G03G 15/657; G03G 2215/00616; G03G 2215/00628; G03G 2215/00759; G03G 2221/169

(57) ABSTRACT

A sheet conveying device includes a body, a first guide in the body, a cover, a second guide in the cover, a detector, and a positioner. The first and second guides form a conveyance path at a closed state of the cover. The detector detects a sheet in the conveyance path and includes a photosensor in the body and a feeler in the cover. The feeler includes a detected portion movable in conjunction with the sheet passing through the conveyance path and a contacted portion. The photosensor has a detection region in which the detected portion entering the detection region is detected. The positioner in the body contacts the contacted portion to position the detected portion in the detection region.

### CROSS-REFERENCE TO RELATED APPLICATION

This patent application is based on and claims priority pursuant to 35 U.S.C. § 119 to Japanese Patent Application No. 2024-036040, filed on Mar. 8, 2024, in the Japan Patent Office, the entire disclosure of which is hereby incorporated by reference herein.

### BACKGROUND

### Technical Field

The present disclosure relates to a sheet conveying device to convey a sheet, an image forming apparatus incorporating the conveying device, and a sheet processing apparatus incorporating the conveying device. Such an image forming apparatus is, for example, a copier, a printer, a facsimile machine, or a multifunction peripheral having at least two of copying, printing, scanning, facsimile, and plotter functions.

### Related Art

An image forming apparatus such as a copier or a printer known in the art includes a sheet conveying device. The sheet conveying device includes a cover that can be opened and closed to expose a part of or an entire of a sheet conveyance path. The cover is opened to remove a sheet jammed in the sheet conveyance path inside the body of the image forming apparatus.

### SUMMARY

The present disclosure described herein provides a sheet conveying device including a body, a first guide, a cover, a second guide, a detector, a feeler, and a positioner. The first guide is in the body. The cover is openably closable the body to expose at least a part of the first guide at an opened state of the cover. The second guide is in the cover and faces the first guide to form a sheet conveyance path at a closed state of the cover. The detector detects a sheet passing through the sheet conveyance path. The detector includes a photosensor in the body and a feeler in the cover. The feeler is movable relative to the second guide. The feeler includes a detected portion and a contacted portion. The detected portion is movable in conjunction with the sheet passing through the sheet conveyance path. The contacted portion is attached to the detected portion. The photosensor has a detection region in which the detected portion entering the detection region is detected by the photosensor. The positioner is in the body to contact the contacted portion to position the detected portion in the detection region when the sheet is not in the sheet conveyance path.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIGS. 2A and 2B are schematic diagrams of the image forming apparatus of FIG. 1 to illustrate an operation to open a cover;

FIG. 3A is a diagram illustrating a detector when a sheet does not pass through a sheet conveyance path;

FIG. 3B is a diagram illustrating the detector of FIG. 3A when a sheet passes through the sheet conveyance path of FIG. 3A;

FIG. 4 is a diagram illustrating the detector of FIGS. 3A and 3B when the cover of FIGS. 3A and 3B is opened;

FIG. 5A is a diagram illustrating a rotatable angle of a feeler when a cover is closed;

FIG. 5B is a diagram illustrating a rotatable angle of a feeler when a cover is opened;

FIGS. 6A and 6B are diagrams illustrating a body side guide and a cover side guide that extend in a width direction;

FIG. 7A is a diagram illustrating a detector in a sheet conveying device according to a comparative example when a cover is not deformed;

FIG. 7B is a diagram illustrating the detector in the sheet conveying device according to the comparative example when the cover is deformed in FIG. 7A;

FIG. 8 is a diagram illustrating the detector of FIG. 7A when the cover of FIG. 7A is opened; and

FIG. 9 is a diagram illustrating an overall configuration of an image forming system as a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

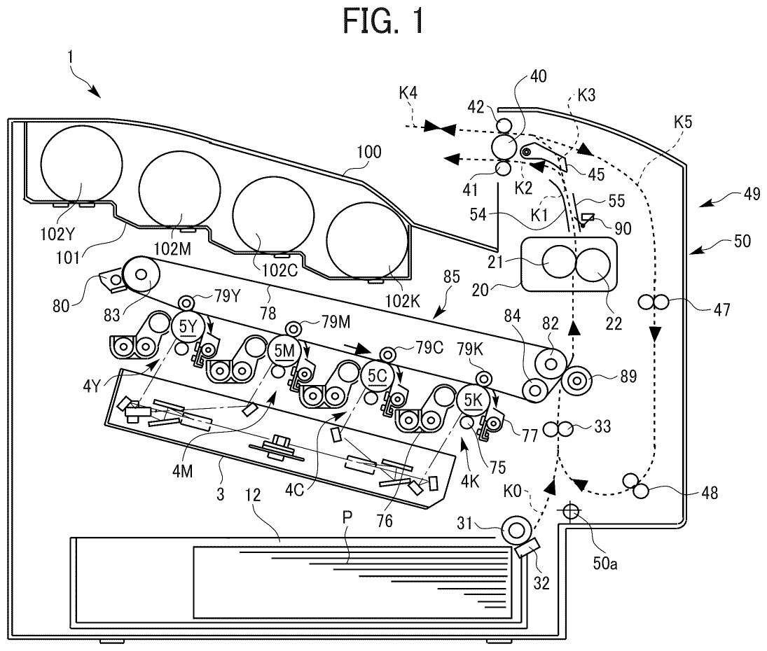

Initially with reference to FIG. 1, a configuration and an operation of an image forming apparatus 1 are described below.

As illustrated in FIG. 1, the image forming apparatus 1 according to the present embodiment is a tandem-type color printer. The image forming apparatus 1 includes a bottle housing 101 in an upper portion of the image forming apparatus 1. The bottle housing 101 accommodates four toner bottles 102Y, 102M, 102C, and 102K containing fresh yellow, magenta, cyan, and black toners, respectively. The four toner bottles 102Y, 102M, 102C, and 102K are detachably attached to the bottle housing 101 for replacement.

Under the bottle housing 101, an intermediate transfer unit 85 is disposed. Facing an intermediate transfer belt 78 (an intermediate transferor) of the intermediate transfer unit 85, image forming devices 4Y, 4M, 4C, and 4K are arranged side by side to form toner images of yellow, magenta, cyan, and black, respectively.

The image forming apparatus 1 includes a sheet feeder 12 (a sheet tray) in a lower portion of the body of the image forming apparatus 1. The sheet feeder 12 contains a stack of multiple sheets P such as sheets of paper stacked on one on another.

In addition, a sheet conveying device 49 is disposed on the right side of the body of the image forming apparatus 1. The sheet conveying device 49 includes a part of the body of the image forming apparatus 1. In the following embodiment, the body of the image forming apparatus 1 is described as one example of a body of the sheet conveying device 49. The sheet conveying device 49 conveys and ejects the sheet P toward a stack portion 100 or reverses (switches back) the sheet P and conveys the sheet P through a duplex printing conveyance path K5. In the sheet conveying device 49, a part of the duplex printing sheet conveyor and a secondary transfer roller 89 described below are disposed on a cover 50 that can be opened and closed.

The image forming devices 4Y, 4M, 4C, and 4K include photoconductor drums 5Y, 5M, 5C, and 5K, respectively. Each of the photoconductor drums 5Y, 5M, 5C, and 5K is surrounded by a charger 75, a developing device 76, a cleaner 77, and a discharger. Image forming processes including a charging process, an exposure process, a developing process, a primary transfer process, and a cleaning process are performed on each of the photoconductor drums 5Y, 5M, 5C, and 5K, forming yellow, magenta, cyan, and black toner images on the photoconductor drums 5Y, 5M, 5C, and 5K, respectively.

A main motor drives to rotate the photoconductor drums 5Y, 5M, 5C, and 5K clockwise in FIG. 1. The chargers 75 uniformly charge the surfaces of the photoconductor drums 5Y, 5M, 5C, and 5K, respectively, which is referred to as the charging process.

After the charging process, the charged outer circumferential surface of each of the photoconductor drums 5Y, 5M, 5C, and 5K reaches an irradiation position at which an exposure device 3 (in other words, a writing device) irradiates and scans the photoconductor drums 5Y, 5M, 5C, and 5K with laser beams, irradiating and scanning the photoconductor drums 5Y, 5M, 5C, and 5K with the laser beams forms electrostatic latent images according to yellow, magenta, cyan, and black image data in the exposure process.

After the exposure process, the irradiated and scanned outer circumferential surface of each of the photoconductor drums 5Y, 5M, 5C, and 5K reaches a developing position at which the developing device 76 is disposed opposite each of the photoconductor drums 5Y, 5M, 5C, and 5K, and the developing device 76 develops the electrostatic latent image formed on the respective photoconductor drums 5Y, 5M, 5C, and 5K, thus forming yellow, magenta, cyan, and black toner images on the photoconductor drums 5Y, 5M, 5C, and 5K in the developing process.

After the developing process, the yellow, magenta, cyan, and black toner images formed on the photoconductor drums 5Y, 5M, 5C, and 5K reach primary transfer nips formed between the photoconductor drums 5Y, 5M, 5C, and 5K and the intermediate transfer belt 78 by four primary transfer bias rollers 79Y, 79M, 79C, and 79K pressed against the four photoconductor drums 5Y, 5M, 5C, and 5K via the intermediate transfer belt 78, respectively, and the yellow, magenta, cyan, and black toner images are primarily transferred onto the intermediate transfer belt 78 as the intermediate transferor in a primary transfer process. After the primary transfer process, residual toner failed to be transferred onto the intermediate transfer belt 78 remains on the photoconductor drums 5Y, 5M, 5C, and 5K slightly.

After the primary transfer process, the residual toner on each of the photoconductor drums 5Y, 5M, 5C, and 5K reaches a cleaning position at which the cleaner 77 is disposed opposite each of the photoconductor drums 5Y, 5M, 5C, and 5K, and a cleaning blade of the cleaner 77 mechanically collects the residual toner from each of the photoconductor drums 5Y, 5M, 5C, and 5K in the cleaning process.

Finally, the cleaned outer circumferential surface of each of the photoconductor drums 5Y, 5M, 5C, and 5K reaches a discharging position at which the discharger is disposed opposite each of the photoconductor drums 5Y, 5M, 5C, and 5K, and the discharger eliminates residual potential from each of the photoconductor drums 5Y, 5M, 5C, and 5K.

Thus, a series of image forming processes performed on the photoconductor drums 5Y, 5M, 5C, and 5K is finished.

The yellow, magenta, cyan, and black toner images formed on the photoconductor drums 5Y, 5M, 5C, and 5K in the developing process are primarily transferred onto an outer circumferential surface of the intermediate transfer belt 78 such that the yellow, magenta, cyan, and black toner images are superimposed on the intermediate transfer belt 78. Thus, a color toner image is formed on the surface of the intermediate transfer belt 78.

The intermediate transfer unit 85 includes the intermediate transfer belt 78 as the intermediate transferor, the four primary transfer bias rollers 79Y, 79M, 79C, and 79K, a secondary transfer backup roller 82, a cleaning backup roller 83, a tension roller 84, and an intermediate transfer belt cleaner 80. The intermediate transfer belt 78 is stretched taut across and supported by the three rollers, that is, the secondary transfer backup roller 82, the cleaning backup roller 83, and the tension roller 84. One of the three rollers, that is, the secondary transfer backup roller 82 is coupled to the main motor to drive and rotate the intermediate transfer belt 78 in a rotation direction indicated by an arrow in FIG. 1.

The four primary transfer bias rollers 79Y, 79M, 79C, and 79K sandwich the intermediate transfer belt 78 together with the four photoconductor drums 5Y, 5M, 5C, and 5K, respectively, thus forming the four primary transfer nips between the intermediate transfer belt 78 and the photoconductor drums 5Y, 5M, 5C, and 5K. A primary transfer bias opposite in polarity to the toner is applied to the primary transfer bias rollers 79Y, 79M, 79C, and 79K.

The intermediate transfer belt 78 is moved in the direction indicated by the arrow in FIG. 1 and sequentially passes through the primary transfer nips formed by the primary transfer bias rollers 79Y, 79M, 79C, and 79K. Thus, the toner images formed on the respective photoconductor drums 5Y, 5M, 5C, and 5K are primarily transferred onto the intermediate transfer belt 78 in a manner of being superimposed one atop another to form a composite color toner image on the intermediate transfer belt 78 in the primary transfer process.

Subsequently, the intermediate transfer belt 78 bearing the composite color toner image reaches a position opposite a secondary transfer roller 89 as a transfer device. At the position, the secondary transfer backup roller 82 and the secondary transfer roller 89 (the transfer device) press against each other via the intermediate transfer belt 78, and the contact portion therebetween is referred to as a secondary transfer nip below. Specifically, the secondary transfer roller 89 is in contact with the secondary transfer backup roller 82 via the intermediate transfer belt 78 at a predetermined pressure (a contact pressure).

At the secondary transfer nip, the composite color toner image (or four-color toner image including yellow, magenta, cyan, and black colors) is secondarily transferred from the intermediate transfer belt 78 onto a sheet P conveyed to the position of the secondary transfer nip, in a secondary transfer process. At this time, residual toner that is not transferred onto the sheet P remains on the surface of the intermediate transfer belt 78.

The surface of the intermediate transfer belt 78 then reaches a position opposite the intermediate transfer belt cleaner 80. At the position, the intermediate transfer belt cleaner 80 collects the residual toner from the intermediate transfer belt 78.

Thus, a series of transfer processes performed on the intermediate transfer belt 78 is completed.

The sheet P is conveyed from the sheet feeder 12 disposed in the lower portion of the body of the image forming apparatus 1 to the secondary transfer nip via a first sheet conveyance path K0 and a second sheet conveyance path K1.

Specifically, the sheet feeder 12 contains a stack of multiple sheets P such as sheets of paper stacked on top of one another. An uppermost sheet P of the multiple sheets P is nipped between a feed roller 31 and a friction pad 32. Rotating the feed roller 31 counterclockwise in FIG. 1 feeds the uppermost sheet P toward a portion between a registration roller pair 33 as a timing roller pair. Guide plates forming the first sheet conveyance path K0 and the second sheet conveyance path K1 guide the uppermost sheet P to the portion between the registration roller pair 33.

The sheet P conveyed to the registration roller pair 33 serving as the timing roller pair temporarily stops at a position of a roller nip (a nip) of the registration roller pair 33 that stops rotating. Subsequently, the registration roller pair 33 rotates to convey the sheet P to the secondary transfer nip in an image forming section, timed to coincide with the arrival of the color toner image on the intermediate transfer belt 78, Thus, the desired color toner image is transferred onto the sheet P.

After the secondary transfer roller 89 transfers the color toner image onto the sheet P at the secondary transfer nip in the image forming section, the sheet P is conveyed to a fixing device 20 via the second sheet conveyance path K1. In the fixing device 20, a fixing belt 21 and a pressure roller 22 apply heat and pressure to the sheet P at a fixing nip formed by the fixing belt 21 and the pressure roller 22 pressing each other to fix the color toner image on the sheet P, which is referred to as a fixing process.

After the fixing process, the sheet P passes through the second sheet conveyance path K1 and is guided to a sheet ejection conveyance path K2 by a bifurcating claw 45 as a switching member, and a first roller 41 and a second roller 40 that function as an ejection roller pair eject the sheet P to the outside of the image forming apparatus 1. The sheets P ejected by the first roller 41 and the second roller 40 are sequentially stacked as output images on the stack portion 100.

Thus, a series of image forming processes performed by the image forming apparatus 1 is completed.

The above-described operations of the image forming apparatus 1 and movement of the sheet P from the sheet feeder 12 to the stack portion 100 are performed when a single-sided print mode is selected. In the single-sided print mode, the image is formed only on the front face of the sheet P.

In the single-sided print mode (or at the end of a double-sided print mode when the sheet P is ejected to the stack portion 100 after the images are printed on both sides of the sheet P), the bifurcating claw 45 as the switching member is at a position (the position illustrated in FIG. 1) after the bifurcating claw 45 rotates counterclockwise about the rotation shaft so as to open the sheet ejection conveyance path K2 and close a relay sheet conveyance path K3.

When the double-sided print mode (a mode in which images are formed on the front face and the back face of the sheet P, respectively) is selected, the image forming apparatus 1 operates as follows, and the sheet P moves as follows.

The processes until the sheet P fed from the sheet feeder 12 reaches the fixing device 20 via the first and second sheet conveyance paths K0 and K1 and the secondary transfer nip are the same as those in the single-sided print mode. After the fixing process (after the image is formed on the front face of the sheet P), the bifurcating claw 45 as the switching member rotates clockwise about the rotation shaft and stops at a position to close the sheet ejection conveyance path K2 and open the relay sheet conveyance path K3. The bifurcating claw 45 as the switching member guides the sheet P to a switchback sheet conveyance path K4 via the relay sheet conveyance path K3.

In the switchback sheet conveyance path K4, a reverse roller 42 temporarily stops rotating when the rear end (the rear end in a conveyance direction) of the sheet P reaches the nip of the reverse roller 42 and the second roller 40 after the rear end of the sheet P passes through the branch point between the relay sheet conveyance path K3 and the duplex printing conveyance path K5. At this time, the rear end of the sheet P having a fixed image on the front face is held by the reverse roller 42, and the front end of the sheet Pis above the stack portion 100 and exposed to the outside of the image forming apparatus 1.

Subsequently, rotating the reverse roller 42 in reverse reverses the conveyance direction of the sheet P and conveys the sheet P toward the double-sided sheet conveyance path K5. At this time, the bifurcating claw 45 as the switching member rotates counterclockwise about the rotation shaft and stops at the position to close the relay sheet conveyance path K3 and open the sheet ejection conveyance path K2 and the double-sided sheet conveyance path K5 as illustrated in FIG. 1.

Referring to FIG. 1, the sheet P guided to the double-sided sheet conveyance path K5 is conveyed by a plurality of conveying rollers 47 and 48 disposed in the double-sided sheet conveyance path K5 and guided to the secondary transfer nip. At the secondary transfer nip, an image is secondarily transferred to the back face of the sheet P similar to the secondary transfer process for the front face of the sheet P. After the secondary transfer process, the sheet P is conveyed to the fixing device 20 to perform the fixing process for the back face of the sheet P.

After the fixing process (that is, after the images are printed on both sides of the sheet P), the sheet P is guided to the nip of the first roller 41 and the second roller 40 via the sheet ejection conveyance path K2, and the first roller 41 and the second roller 40 ejects the sheet P to the outside of the image forming apparatus 1 as described above. As a result, the sheets P are sequentially stacked on the stack portion 100.

The fixing device 20 includes the fixing belt 21, the pressure roller 22, and a planar heater 23.

The fixing belt 21 is an endless belt including a base layer and a release layer as a surface layer layered on the base layer. The base layer is made of metal such as nickel or stainless steel or resin such as polyimide. The release layer is made of tetrafluoroethylene-perfluoroalkylvinylether copolymer (PFA), polytetrafluoroethylene (PTFE), polyimide, polyetherimide, or polyethersulfone (PES). The fixing belt 21 according to the present embodiment does not include an elastic layer made of rubber between the base layer and the release layer as the surface layer to reduce a manufacturing cost.

Inside a loop of the fixing belt 21, the planar heater 23 as a heat source is disposed. The planar heater 23 contacts the inner circumferential surface of the fixing belt 21. The planar heater 23 is pressed against the pressure roller 22 via the fixing belt 21 to form the fixing nip through which the sheet Pis conveyed. The planar heater 23 disposed inside the loop of the fixing belt 21 directly heats the fixing belt 21. The outer circumferential surface of the fixing belt 21 heated by the planar heater 23 heats the toner image on the sheet P.

The pressure roller 22 includes a cored bar and an elastic layer made of rubber and formed on the cored bar.

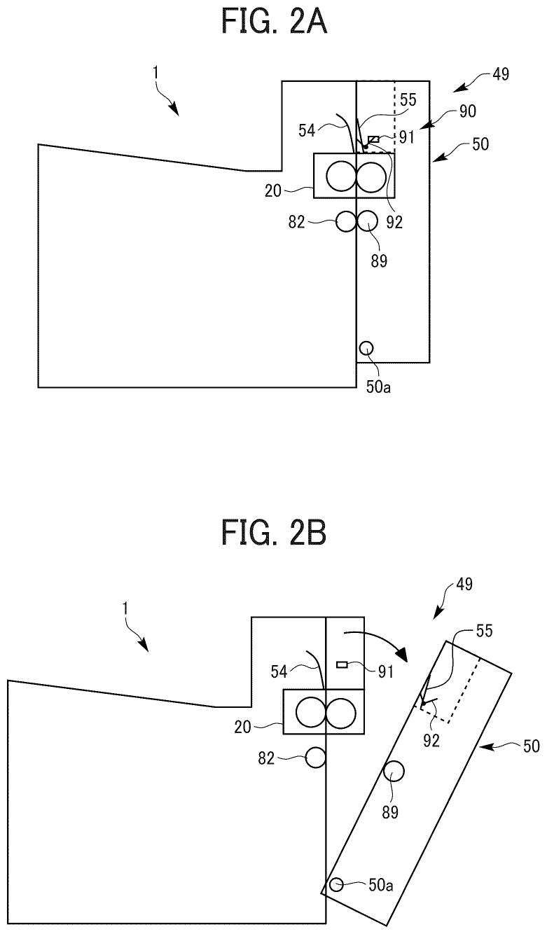

The following describes a characteristic configuration and operation of the sheet conveying device 49 installed in the image forming apparatus 1 in detail with reference to FIGS. 2A to 6B.

The sheet conveying device 49 conveys the sheet P.

As illustrated in FIGS. 2A and 2B, the sheet conveying device 49 includes the cover 50 on the body of the image forming apparatus 1. The cover 50 rotates about a support shaft 50a attached to the body of the image forming apparatus 1 to open and close the inside of the body of the image forming apparatus 1.

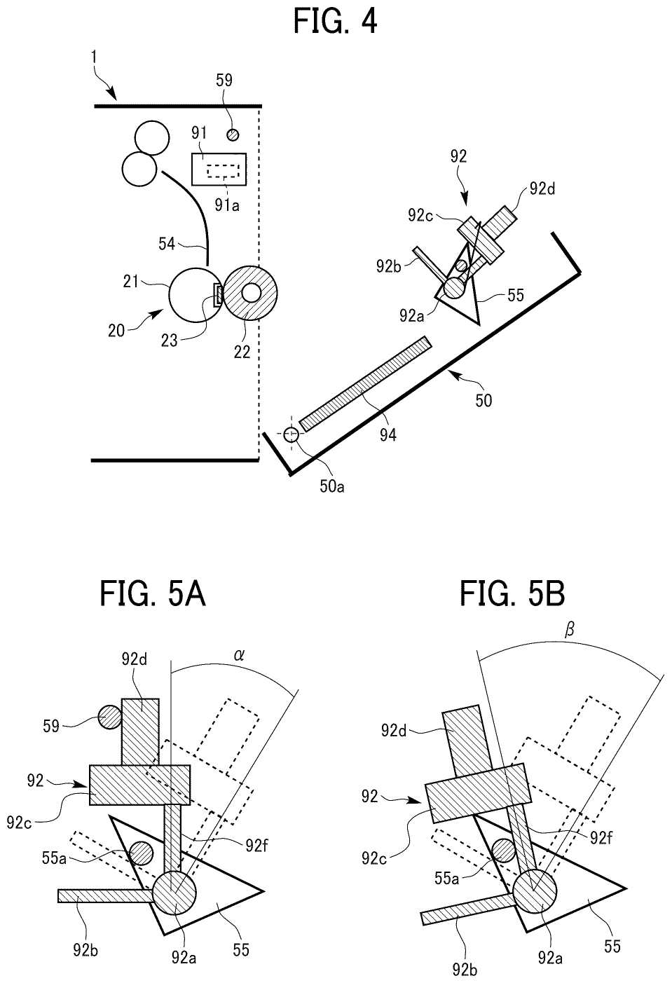

Specifically, the cover 50 is closed as illustrated in FIGS. 1, 2A, and 3A, which is referred to as a closed state of the cover 50, and rotated clockwise (in the direction indicated by the arrow in FIG. 2B) about the support shaft 50a to open the cover 50 as illustrated in FIGS. 2B and 4, which is referred to as an opened state of the cover 50, and opening the cover 50 opens and exposes a part of the inside of the body of the image forming apparatus 1 such as the first sheet conveyance path K0, the second sheet conveyance path K1, the fixing device 20, and the intermediate transfer unit 85. As a result, the above-described configuration enables removing the sheet jammed in the first sheet conveyance path K0 or the second sheet conveyance path K1, detaching the fixing device 20 or the intermediate transfer unit 85, performing maintenance of the fixing device 20 or the intermediate transfer unit 85, and attaching the fixing device 20 or the intermediate transfer unit 85. Rotating the cover 50 opened as illustrated in FIGS. 2B and 4 counterclockwise in FIGS. 2B and 4 about the support shaft 50a closes the cover 50 as illustrated in FIGS. 1, 2A, and 3A. As a result, the image forming apparatus can perform the printing operation described above with reference to FIG. 1.

The closed state of the cover 50 means that the body of the image forming apparatus 1 is closed by the cover 50. On the other hand, the opened state of the cover 50 means that the body of the image forming apparatus 1 is opened by the cover 50.

When a user sets the sheets P to the sheet feeder 12 or takes out the sheet P printed from the stack portion 100, the user stands at the front side as an operation side of the image forming apparatus 1. The cover 50 is disposed on the right side or the left side of the body of the image forming apparatus 1 and functions as a side cover.

In the sheet conveying device 49 or the image forming apparatus 1 as described above and will be described later with reference to FIGS. 1 to 4, the second sheet conveyance path K1 as a sheet conveyance path is arranged downstream from the fixing device 20 in the conveyance direction. Two guides (a body side guide 54 and a cover side guide 55) face each other with a space through which the sheet P can pass to form the second sheet conveyance path K1.

The body side guide 54 as a first guide is in the body of the image forming apparatus 1. The cover side guide 55 as a second guide is in the cover 50 and faces the body side guide 54 to form the second sheet conveyance path K1 as the sheet conveyance path.

In the present embodiment, each of the body side guide 54 and the cover side guide 55 may have a plate shape curved to guide the sheet P in the sheet conveyance direction and multiple ribs extending in the sheet conveyance direction on the surface of the plate shape.

The cover 50 including the cover side guide 55 as the second guide rotates together with the cover side guide 55 about the support shaft 50a with respect to the body of the image forming apparatus 1 to expose a part of or an entire of the body side guide 54 as the first guide.

In other words, rotating the cover 50 together with the cover side guide 55 about the support shaft 50a and opening the cover 50 including the cover side guide 55 as illustrated in FIGS. 2B and 4 separates the cover side guide 55 from the body side guide 54 fixed on the body of the image forming apparatus 1. As a result, the user can easily remove the sheet P jammed (stopped) in the vicinity of the second sheet conveyance path K1.

In addition, opening the cover 50 as illustrated in FIGS. 2B and 4 exposes the fixing device 20 installed in the image forming apparatus 1. This enables jam processing for the sheet P jammed at the fixing nip of the fixing device 20 and maintenance of the fixing device 20.

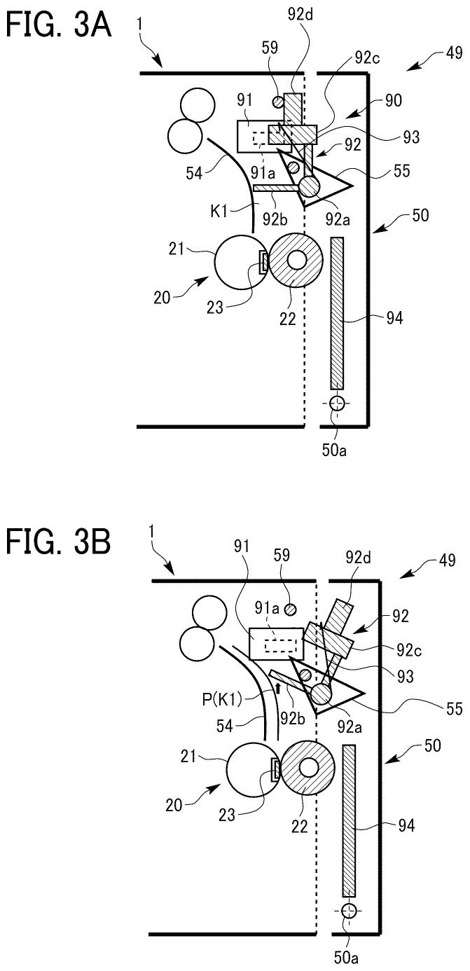

With reference to FIG. 3 and FIG. 1, a detector 90 is disposed adjacent to the second sheet conveyance path K1 formed by the sheet conveying device 49 (the image forming apparatus 1). The detector 90 optically detects whether the sheet P passing through the second sheet conveyance path K1 is in the second sheet conveyance path K1 as the sheet conveyance path.

With reference to FIGS. 3A to 5B, the detector 90 includes a transmission-type photosensor 91 as a photosensor, a feeler 92 (a rotator), and a torsion spring 93 as a biasing member.

The transmission-type photosensor 91 as the photosensor is not in the cover 50 but is in the body of the image forming apparatus 1. The transmission-type photosensor 91 is always fixed to the body of the image forming apparatus 1 regardless of the opening and closing of the cover 50. The transmission-type photosensor 91 includes a light emitting element and a light receiving element that face each other. A gap between the light emitting element and the light receiving element is designed so that the feeler 92 can come in and out of the gap.

The feeler 92 is disposed to be rotatable about a rotation shaft 92a with respect to the cover side guide 55. In other words, the feeler 92 is not in the body of the image forming apparatus 1 but in the cover 50. Therefore, the feeler 92 rotates about the support shaft 50a together with the cover 50 in accordance with the opening and closing of the cover 50.

Since a power supply to supply power to the transmission-type photosensor 91 is in the body of the image forming apparatus 1, the transmission-type photosensor 91 is in the body of the image forming apparatus 1 in order to continue power supply from the power supply to the transmission-type photosensor 91 regardless of the opening and closing of the cover 50. In order to prevent the feeler 92 from contacting and rubbing the image fixed on the sheet P, the feeler 92 is disposed on the cover side guide 55 in the cover 50. Further, to detect the opening and closing of the cover 50, the detector 90 is configured as described above.

The transmission-type photosensor 91 has a detection region 91a that is defined as a region in which the transmission-type photosensor 91 can detect whether the feeler 92 is in the region. As illustrated in FIGS. 3A and 3B, the feeler 92 in the closed cover 50 is rotated in conjunction with the passage of the sheet P. As a result, the feeler 92 comes in and out of the detection region 91a.

In detail, the feeler 92 has a detected portion 92c. The biasing force of the torsion spring 93 biases the feeler 92 so as to rotate the feeler 92 counterclockwise in FIG. 3A. As illustrated in FIG. 3A, the detected portion 92c is in the detection region 91a of the transmission-type photosensor 91 when the sheet P is not in the second sheet conveyance path K1 between the body side guide 54 and the cover side guide 55. As a result, the detected portion 92c blocks light emitted from the light emitting element to the light receiving element in the transmission-type photosensor 91. Blocking the light causes the light receiving element of the transmission-type photosensor 91 to transmit an ON signal (or an OFF signal) to a controller, and the controller determines that the sheet P is not in the second sheet conveyance path K1.

In contrast, as illustrated in FIG. 3B, the sheet P in the second sheet conveyance path K1 between the body side guide 54 and the cover side guide 55 pushes the feeler 92 and rotates the feeler 92 clockwise in FIG. 3B about the rotation shaft 92a against the biasing force of the torsion spring 93. As a result, the detected portion 92c moves to the outside of the detection region 91a of the transmission-type photosensor 91, and the light emitted from the light emitting element is emitted to the light receiving element. The light receiving element receiving the light in the transmission-type photosensor 91 transmits the OFF signal (or the ON signal) to the controller, and the controller determines that the sheet P is in the second sheet conveyance path K1. In other words, the detector 90 includes the feeler 92 movable relative to the cover side guide 55, and the feeler 92 includes the detected portion 92c movable in conjunction with the sheet passing through the second sheet conveyance path K1. The transmission-type photosensor 91 has the detection region 91a in which the detected portion 92c entering the detection region 91a is detected by the transmission-type photosensor 91. As a result, the detector 90 detects the sheet passing through the second sheet conveyance path K1.

The controller uses the above-described results detected by the detector 90 regarding whether the sheet P is in the sheet conveyance path K1 to check the timing of passage of the sheet P in the second sheet conveyance path K1, determine whether the sheet P passes the second sheet conveyance path K1, and determine whether the sheet P is jammed in the second sheet conveyance path K1.

The sheet conveying device 49 of the image forming apparatus 1 includes a positioner 59. As illustrated in FIGS. 3A and 5A, when the sheet P is not in the second sheet conveyance path K1 as the sheet conveyance path formed by the closed cover 50, the positioner 59 contacts a contacted portion 92d of the feeler 92 and positions the feeler 92 with respect to the transmission-type photosensor 91.

The positioner 59 has a pin shape and is in the body of the image forming apparatus 1, not in the cover 50. Regardless of the opening and closing of the cover 50, the positioner 59 is fixed in the body of the image forming apparatus 1. Specifically, the positioner 59 in the body of the image forming apparatus 1 contacts the contacted portion 92d of the feeler 92 to position the detected portion 92c of the feeler 92 in the detection region 91a of the transmission-type photosensor 91 when the sheet is not in the second sheet conveyance path K1. The position at which the positioner 59 is fixed in the body is designed so as not to block the sheet P conveyed in the sheet conveyance path.

Specifically, as illustrated in FIG. 5A, the feeler 92 has a substantial V-shape or a substantial boomerang-shape like a member bent about the rotation shaft 92a. The feeler 92 includes the rotation shaft 92a, a lever 92b, the detected portion 92c, the contacted portion 92d as a first contacted portion, and a second contacted portion 92f as another contacted portion.

The lever 92b projects from the rotation shaft 92a to contact the sheet P passing through the second sheet conveyance path K1 as the sheet conveyance path. As described above with reference to FIG. 3B, the sheet P pushes the lever 92b, and thus the feeler 92 rotates about the rotation shaft 92a. The cover side guide 55 has a sheet guide face having an opening. The lever 92b of the feeler 92 protrudes from the opening toward the body side guide 54 (in other words, the second sheet conveyance path K1).

The detected portion 92c is disposed at a position away from the lever 92b via the rotation shaft 92a. The rotation shaft 92a is interposed between the detected portion 92c and the lever 92b. In other words, the detected portion 92c is separated from the lever 92b and the rotation shaft 92a by the second contacted portion 92f. The detected portion 92c comes in and out of the detection region 91a of the transmission-type photosensor 91. As described above with reference to FIGS. 3A and 3B, rotating the feeler 92 forward and reverse about the rotation shaft 92a causes the detected portion 92c of the feeler 92 to come in and out of the detection region 91a. As a result, the light emitted from the light emitting element is blocked by the detected portion 92c or emitted to the light receiving element.

The contacted portion 92d as the first contacted portion is positioned to be farther from the rotation shaft 92a than the detected portion 92c. The contacted portion 92d contacts the positioner 59 and receives the biasing force of the torsion spring 93 to prevent the feeler 92 from rotating too much about the rotation shaft 92a counterclockwise in FIG. 5A.

Integrally forming the contacted portion 92d and the detected portion 92c enhances the positional accuracy of the detected portion 92d with respect to the detection region 91a when the cover 50 is closed (in other words, when the contacted portion 92d contacts the positioner 59).

The second contacted portion 92f functions as a portion that relays the rotation shaft 92a and the detected portion 92c and is configured to contact a second positioner 55a as another positioner of the cover side guide 55 to position the feeler 92 with respect to the cover side guide 55 at the opened state of the cover 50.

On the other hand, the cover side guide 55 includes the second positioner 55a and the torsion spring 93.

The second positioner 55a has a pin shape and is formed integrally with the cover side guide 55. After the cover 50 is opened, the second positioner 55a contacts the second contacted portion 92f of the feeler 92 to determine the position of the feeler 92 with respect to the cover side guide 55 as illustrated in FIG. 5B. The second contacted portion 92f contacts the second positioner 55a and receives the biasing force of the torsion spring 93 to prevent the feeler 92 from rotating too much about the rotation shaft 92a counterclockwise in FIG. 5B.

The torsion spring 93 functions as a biasing member that biases the feeler 92 so that the feeler 92 rotates and contacts the positioner 59 (or the second positioner 55a). The torsion spring 93 has a coil portion inserted into the rotation shaft 92a, one arm coupled to the cover side guide 55, and the other arm coupled to a portion of the feeler 92 that is the portion away from the rotation shaft 92a such as the detected portion 92c. The biasing force of the torsion spring 93 is set to a magnitude such that the sheet P pushing the lever 92b can rotate the feeler 92 clockwise in FIG. 5 about the rotation shaft 92a, and to a magnitude such that the feeler 92 rotates counterclockwise in FIG. 5 about the rotation shaft 92a after the sheet P does not push the lever 92b.

After the cover 50 is closed, the feeler 92 can rotate at an angle α as illustrated in FIG. 5A. After the cover 50 is opened, the feeler 92 can rotate at an angle β as illustrated in FIG. 5B. The angle α is designed to be smaller than the angle β (α<β). In other words, a rotatable angle α of the feeler 92 at the closed state of the cover 50 is designed to be smaller than a rotatable angle β of the feeler 92 at the opened state of the cover 50.

The above-described configuration causes the feeler 92 to reliably contact the first positioner 59 while the opened cover 50 (in which the feeler 92 contacts the second positioner 55a) is closed, which reliably determines the position of the feeler 92 with respect to the transmission-type photosensor 91. As a result, the above-described configuration prevents the detector from causing erroneous detection due to poor positional accuracy of the feeler 92 with respect to the transmission-type photosensor 91.

As described above, the positioner 59 disposed in the body of the image forming apparatus 1 determines the position of the feeler 92 of the detector 90 disposed in the cover 50 with respect to the transmission-type photosensor 91 of the detector 90 disposed in the body of the image forming apparatus 1.

The above-described configuration easily determines the position of the feeler 92 in the closed cover 50 with respect to the transmission-type photosensor 91 even if the cover 50 has deformation such as warping.

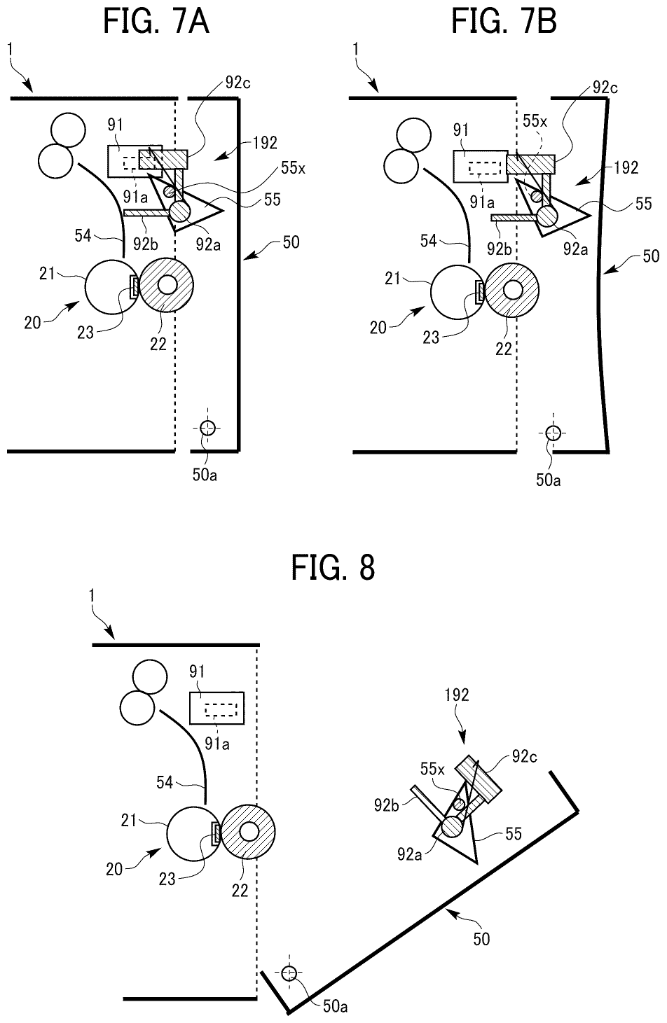

Specifically, a comparative example is described below with reference to FIGS. 7A, 7B, and 8. In the comparative example, a positioner 55x disposed in the cover side guide 55 contacts the feeler 192 in the closed cover 50 to determine the position of the feeler 192 with respect to the transmission-type photosensor 91 (see FIGS. 7A and 8). As illustrated in FIG. 7B, the deformation of the cover 50 such as the warping is likely to cause the deviation of the detected portion 92c of the feeler 192 in the closed cover 50 from the detection region 91a of the transmission-type photosensor 91. In such a case, the position of the feeler 92 with respect to the transmission-type photosensor 91 is not correctly fixed, and the detector 90 cannot sufficiently detect the passage of the sheet P or the occurrence of the sheet jam in the second sheet conveyance path K1.

In contrast, since the positioner 59 in the present embodiment is disposed in the body of the image forming apparatus 1 and determines the position of the feeler 92 in the closed cover 50 with respect to the transmission-type photosensor 91, the positional accuracy of the feeler 92 in the closed cover 50 with respect to the transmission-type photosensor 91 can be enhanced even if the cover 50 is deformed.

In particular, the fixing device 20 includes the fixing belt 21 including no elastic layer as described above. Such a fixing belt has low strength. If the detector 90 has a low jam detection accuracy, the sheet jam is likely to occur, and the jammed sheet is wound around the fixing belt 21. In such a case, the jammed sheet P presses the planar heater 23 via the fixing belt 21 and may break the planar heater 23.

In contrast, the detector 90 according to the present embodiment has a high positional accuracy of the feeler 92 with respect to the transmission-type photosensor 91, and thus the jam of the sheet P is unlikely to be erroneously detected. As a result, the above-described problem is unlikely to occur.

Preferably, the transmission-type photosensor 91 and the positioner 59 are disposed at the body side guide 54.

The above-described configuration can enhance the positional accuracy of the detector 90 with respect to the body side guide 54.

The transmission-type photosensor 91 and the positioner 59 may be integrally formed as a single component. The above-described configuration can further enhance the positional accuracy of the detector 90 because a dimensional error or an assembly error is less likely to occur in the positional accuracy of the positioner 59 with respect to the transmission-type photosensor 91.

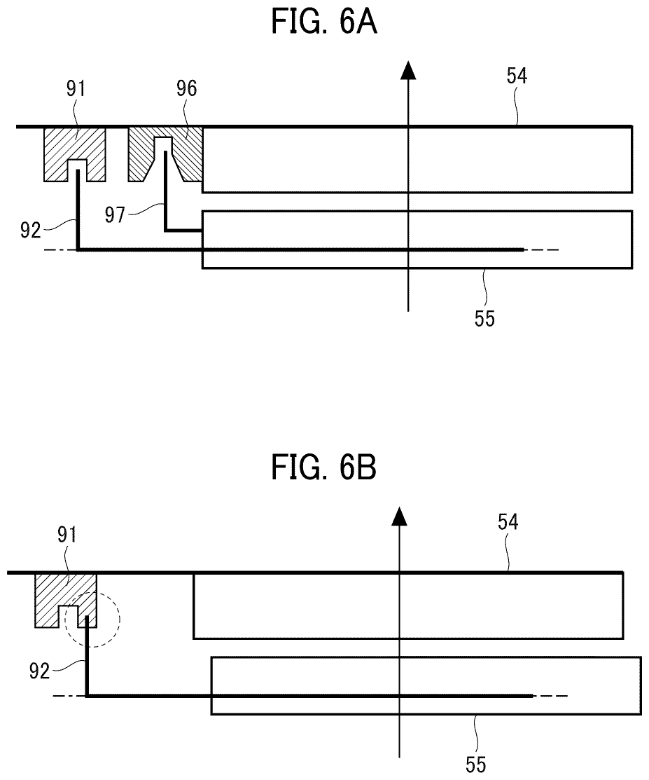

As illustrated in FIG. 6A, the cover side guide 55 in the image forming apparatus 1 includes an engaging portion 97, and the body side guide 54 in the image forming apparatus 1 includes an engaged portion 96. Closing the cover 50 causes the engaging portion 97 to engage with the engaged portion 96, which determines the position of the cover side guide 55 with respect to the body side guide 54 in a width direction. The width direction of the cover side guide 55 is the same as the direction perpendicular to each of the surfaces of the paper on which FIGS. 1 to 4 are drawn, the lateral direction in FIG. 6A, and the direction orthogonal to the sheet conveyance direction in which the sheet P passes through the second conveyance path K1 and in parallel to the surface of the sheet P.

FIG. 6B is a schematic diagram illustrating a comparative example not including the above-described positioning mechanism in the width direction. If the deformation occurs in the cover 50, the position of the cover side guide 55 in the width direction is shifted with respect to the body side guide 54. Closing the cover 50 deformed as described above causes the feeler 92 disposed on the cover side guide 55 to ride on the transmission-type photosensor 91 disposed on the body side guide 54 in the body of the image forming apparatus 1 as illustrated in the circle drawn by a dashed line in FIG. 6B. As a result, the detector 90 does not operate normally.

In contrast, in the present embodiment, the cover side guide 55 includes the engaging portion 97, and the body side guide 54 includes the engaged portion 96, which serve as the positioning mechanism in the width direction as illustrated in FIG. 6A. Even if the cover 50 having the deformation that shifts the position of the cover side guide 55 in the width direction with respect to the body side guide 54 is closed, the engaging portion 97 (a striker) engages with the engaged portion 96 having an opening expanding in a conical shape in the width direction to correct the shift of the cover side guide 55. As a result, the above-described configuration in the present embodiment overcomes the disadvantage that the feeler 92 disposed on the cover side guide 55 rides on the transmission-type photosensor 91 disposed on the body side guide 54 in the body of the image forming apparatus 1. The position of the feeler 92 in the width direction with respect to the transmission-type photosensor 91 is accurately determined, and the detector 90 operates under normal operating conditions.

With reference to FIGS. 3A, 3B, and 4, the cover 50 includes a reinforcement 94 to reinforce the strength of the cover 50. The reinforcement 94 is in a region closer to the support shaft 50a than the position of the feeler 92. In other words, the reinforcement 94 in the cover 50 is closer to the support shaft 50a than to the feeler 92. The reinforcement 94 is made of, for example, a metal plate to reinforce the mechanical strength of the cover 50 made of resin and prevent the cover 50 from being deformed. The more the reinforcement 94 reinforces the entire area of the cover 50, the more the purpose of use is achieved, but the weight of the cover 50 is increased.

As described above, in the present embodiment, the positioner 59 disposed in the body of the image forming apparatus 1 determines the position of the feeler 92 of the detector 90 disposed in the cover 50 with respect to the transmission-type photosensor 91 of the detector 90 disposed in the body of the image forming apparatus 1. The above-described configuration easily determines the position of the feeler 92 in the closed cover 50 with respect to the transmission-type photosensor 91 even if the cover 50 has the deformation.

Accordingly, the reinforcement 94 in the present embodiment is in a region between the support shaft 50a in the cover 50 and the feeler 92 (the cover side guide 55) as an optimum region. In the optimum region, the positional accuracy of the feeler 92 with respect to the transmission-type photosensor 91, the increase in the strength of the cover 50, and weight reduction of the cover 50 can be achieved in a well-balanced manner.

A description is given of a modification.

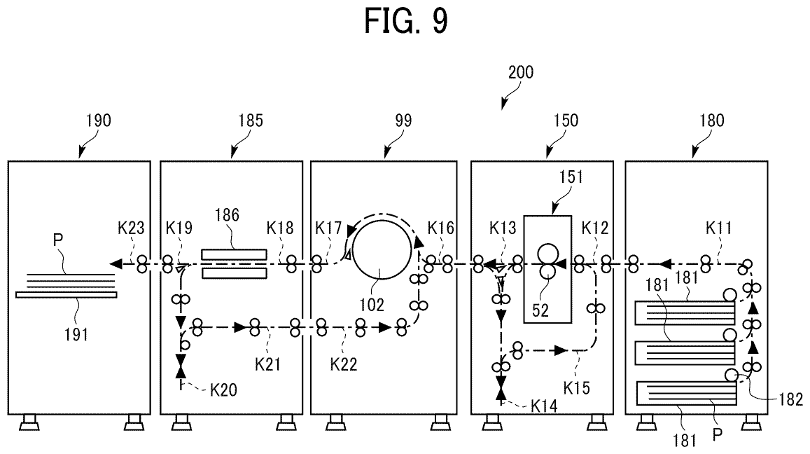

As illustrated in FIG. 9, an image forming system 200 as the modification includes an inkjet printer 99 as the image forming apparatus, a coating apparatus 150 as a sheet processing apparatus attached to the inkjet printer 99 to perform pre-processing, a dryer 185 attached to the inkjet printer 99 to perform post-processing.

FIG. 9 is a diagram illustrating the inkjet printer 99 as the image forming apparatus; the coating apparatus 150 to coat coating liquid as the pre-processing on the sheet P conveyed to the image forming apparatus 1; a sheet feeder 180 to feed the sheet P such as a paper sheet; the dryer 185 to dry ink on the sheet P as the post-processing on the sheet P after image formation; and a sheet ejection device 190 to stack the sheet P ejected from the dryer 185.

As illustrated in FIG. 9, the image forming system 200 according to the present modification includes the sheet feeder 180, the coating apparatus 150, the inkjet printer 99 as the image forming apparatus, the dryer 185, and the sheet ejection device 190 that are connected and arranged in this order from upstream to downstream in the sheet conveyance direction.

With reference to FIG. 9, the operation of the image forming system 200 is briefly described.

In response to inputting a print command together with image data from a personal computer to a controller of the image forming system 200, a feed roller 182 feeds the sheet P from a sheet feed tray 181 via a first sheet conveyance path K11. Conveyance rollers convey the sheet P fed from the sheet feed tray 181 to the coating apparatus 150 as the sheet processing apparatus that performs the pre-processing via the first sheet conveyance path K11.

In the present modification, the sheet feeder 180 is configured to feed cut sheets stored in the sheet feed tray 181 but may be configured to feed roll sheets.

Subsequently, the sheet P conveyed to the coating apparatus 150 is conveyed to a coating apparatus main portion 151 via a second sheet conveyance path K12. The coating apparatus main portion 151 applies coating liquid as pre-processing liquid to the lower face of the sheet P that is a front face during image formation to reduce bleeding and bleed-through, which is a coating process. After the coating process, the sheet P coated with the coating liquid is conveyed to a fourth sheet conveyance path K14 that is a reverse passage. After the sheet P enters the fourth sheet conveyance path K14, the conveyance direction is reversed, and the sheet is turned over. The sheet face coated with the coating liquid becomes the front face (an upper face). Subsequently, the sheet Pis conveyed to the inkjet printer 99 as the image forming apparatus via a third sheet conveyance path K13.

When a duplex print mode to form images on both sides of the sheet P is selected in the image forming apparatus 1, the coating liquid is applied to both sides of the sheet P. To apply the coating liquid to both sides of the sheet P, the sheet P having one side coated with the coating liquid is conveyed to the fourth sheet conveyance path K14. After the sheet P enters the fourth sheet conveyance path K14, the conveyance direction is reversed, and the sheet is turned over. Subsequently, the sheet Pis conveyed to a fifth sheet conveyance path K15 (a duplex print conveyance path) to convey the sheet P to the coating apparatus main portion 151 again. The coating apparatus main portion 151 applies the coating liquid to the other side of the sheet P, and the sheet Pis conveyed to the inkjet printer 99 as the image forming apparatus via the third sheet conveyance path K13.

The configuration and operation of the coating apparatus main portion 151 in the coating apparatus 150 is described below in detail with reference to FIGS. 3A to 8.

The sheet P conveyed to the inkjet printer 99 as the image forming apparatus passes through a sixth sheet conveyance path K16. Subsequently, a conveyance drum 102 conveys the sheet P. While the conveyance drum 102 conveys the sheet P, the ink is ejected to the front face (the upper face) of the sheet P to form a desired image (an ink image). At this time, since the coating liquid is applied to the front face of the sheet P as the pre-processing, the bleeding and the bleed-through of the image are prevented.

The sheet P on which the image is formed is conveyed to the dryer 185 that is the sheet processing apparatus to perform the post-processing via a seventh sheet conveyance path K17.

The sheet P conveyed to the dryer 185 passes through an eighth sheet conveyance path K18 and is conveyed to a dryer unit 186 to dry the image on the front side of the sheet P which is referred to as one side of the sheet P below. The sheet P bearing the image dried is conveyed to the sheet ejection device 190 via a ninth sheet conveyance path K19.

When the above-described duplex print mode is selected, an image is formed on the back side of the sheet P which is referred to as the other side of the sheet P. To form the image on the other side of the sheet P, the sheet Pis conveyed to a tenth sheet conveyance path K₂O (that is a reverse passage) after the ink image on the one side is dried. After the sheet P enters the tenth sheet conveyance path K₂O, the conveyance direction is reversed, and the sheet P is turned over. Subsequently, the sheet Pis conveyed to an eleventh sheet conveyance path K21 and a twelfth conveyance path K22 that are duplex print conveyance paths to convey the sheet P to the conveyance drum 102 in the inkjet printer 99 as the image forming apparatus again. A desired image (an ink image) is formed on the other side of the sheet P on the conveyance drum 102, and the sheet P is conveyed to the dryer 185 again via the seventh sheet conveyance path K17. The dryer unit 186 dries the image on the other side of the sheet P, and the sheet Pis conveyed to the sheet ejection device 190 via the ninth sheet conveyance path K19.

The sheet P conveyed to the sheet ejection device 190 is stacked on the an output tray 191 after passing through a thirteenth sheet conveyance path K23.

In this way, a series of operations in the image forming system 200 is completed.

In the image forming system 200 according to the modification, the coating apparatus 150 and the dryer 185 as the sheet processing apparatus includes a sheet conveying device that conveys the sheet P in the sheet conveyance paths K12 to K15 and K18 to K21 (formed by the first guide and the second guide that face each other). The sheet conveying device such as the coating apparatus 150 or the dryer 185 may be configured in the same manner as the sheet conveying device 49 described above with reference to FIGS. 2A to 6B.

Further, the sheet conveying device installed in the sheet feeder 180, the inkjet printer 99 as the image forming apparatus, or the sheet ejection device 190 may be configured in the same manner as the sheet conveying device 49 described above with reference to FIGS. 2A to 6B.

The above-described configuration easily determines the position of a feeler in a closed cover with respect to a photosensor even if the cover has a deformation.

As described above, the image forming apparatus 1 according to the present embodiment includes the body side guide 54 as the first guide disposed in the body of the image forming apparatus 1 and the cover side guide 55 as the second guide that faces the body side guide 54 to form the sheet conveyance path K1. In addition, the image forming apparatus 1 includes the cover 50 including the cover side guide 55, and the cover 50 can expose a part of or an entire of the body side guide 54. Further, the image forming apparatus 1 includes the detector 90 detecting whether the sheet P exists in and passes through the first sheet conveyance path K1. The detector 90 includes the transmission-type photosensor 91 as the photosensor disposed in the body of the image forming apparatus 1 and the feeler 92 that can move with respect to the cover side guide 55. The feeler 92 is configured to come in and out of the detection region 91a of the transmission-type photosensor 91 in conjunction with the passage of the sheet P when the cover 50 closes the body of the image forming apparatus 1. In addition, the positioner 59 is disposed in the body of the image forming apparatus 1.

The positioner 59 contacts the contacted portion 92d of the feeler 92 and determines the position of the feeler 92 with respect to the transmission-type photosensor 91 when the sheet P is not in the first sheet conveyance path K1 formed by the cover 50 closing the body of the image forming apparatus 1.

As a result, even if the cover 50 is deformed, the position of the feeler 92 with respect to the transmission-type photosensor 91 is easily determined after the cover 50 is closed.

The above-described embodiment and modification of the present disclosure are applied to the sheet conveying device 49 disposed in the image forming apparatus 1 forming the color toner image. However, the present disclosure may be also applied to a sheet conveying device disposed in a monochrome image forming apparatus.

Further, the above-described embodiment and modification of the present disclosure are applied to the sheet conveying device 49 provided for the image forming apparatus 1 that employs electrophotography. However, the present disclosure is not limited to the above-described sheet conveying device. For example, the present disclosure is also applicable to a sheet conveying device provided for an image forming apparatus that employs an inkjet method or a stencil printing machine. The present disclosure may be also applicable to an automatic document feeder as the sheet conveying device conveying a document as the sheet.

In the present embodiment and modification, the present disclosure is applied to the sheet conveying device 49 (in the image forming apparatus 1) including the cover 50 that includes the duplex printing conveyance path K5. However, the present disclosure may be applied to the sheet conveying device (the image forming apparatus) including the cover that does not include the duplex printing conveyance path.

In the present embodiment, the two guides that are the body side guide 54 and the cover side guide 55 form the second sheet conveyance path K1. Opening the cover 50 separates the cover side guide 55 in the cover 50 from the body side guide 54 in the body of the image forming apparatus 1. Two guides forming the first sheet conveyance path K0 may be configured so that opening the cover 50 separates the guide in the cover 50 from the guide in the body of the image forming apparatus 1.

Any of the cases described above exhibits substantially the same advantages as the advantages of the present embodiment and modification.

The above-described embodiments are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. The number, position, and shape of the components described above are not limited to those embodiments described above. Desirable number, position, and shape can be determined to perform the present disclosure.

In the present description, the term “sheet” is defined as any conveyed member that can be conveyed in the sheet conveyance path, such as general paper, coated paper, label paper, overhead projector (OHP) transparency, or a film sheet.

Note that aspects of the present disclosure may be applicable to, for example, combinations of first to twelfth aspects as follows.

### First Aspect

In a first aspect, a sheet conveying device includes a first guide, a second guide, an opening and closing portion such as the cover, a detector, and a positioner. The first guide is disposed in an opened and closed portion such as the body. The second guide faces the first guide to form a sheet conveyance path. The opening and closing portion can expose a part or an entire of the first guide. The detector can detect a sheet passing through the sheet conveyance path. The detector includes a photosensor and a feeler. The photosensor is disposed in the opening and closing portion. The feeler is disposed to be movable with respect to the second guide. Under a state in which the opening and closing portion closes the opened and closed portion, the feeler moves in conjunction with passage of the sheet in the sheet conveyance path to come in and out of a detection region of the photosensor. The positioner is disposed in the opened and closed portion. When the sheet is not in the sheet conveyance path under the state in which the opening and closing portion closes the opened and closed portion, the positioner contacts a contacted portion of the feeler to determine a position of the feeler with respect to the photosensor.

### Second Aspect

In a second aspect, the photosensor and the positioner in the sheet conveying device according to the first aspect are disposed on the first guide.

### Third Aspect

In a third aspect, the photosensor and the positioner in the sheet conveying device according to the first aspect or the second aspect are integrally formed.

### Fourth Aspect

In a fourth aspect, a rotatable angle of the feeler under a state in which the opening and closing portion closes the opened and closed portion is smaller than a rotatable angle of the feeler under a state in which the opening and closing portion opens the opened and closed portion in the sheet conveying device according to any one of the first to third aspects.

### Fifth Aspect

In a fifth aspect, the second guide in the sheet conveying device according to any one of the first to fourth aspects includes a second positioner contacting a second contacting portion of the feeler to determine a position of the feeler with respect to the second guide under a state in which the opening and closing portion opens the opened and closed portion.

### Sixth Aspect

In a sixth aspect, the feeler in the sheet conveying device according to any one of the first to fifth aspects includes a lever portion and a detected portion. The lever portion is disposed to be rotatable about a rotation shaft with respect to the second guide. The lever portion is disposed at a position away from the rotation shaft. The lever portion can contact the sheet passing through the sheet conveying path. The detected portion is disposed at a position away from the lever portion on an opposite side with respect to the rotation shaft. The detected portion can come in and out of the detection region. The contacted portion is disposed at a position further away from the rotation shaft with respect to the detected portion.

### Seventh Aspect

In a seventh aspect, the second guide in the sheet conveying device according to any one of the first to sixth aspects includes a biasing member biasing the feeler to move the feeler toward the positioner so that the feeler contact the positioner.

### Eighth Aspect

In an eighth aspect, the second guide in the sheet conveying device according to any one of the first to seventh aspects includes an engaging portion engaging with an engaged portion of the first guide to determine a position in a width direction with respect to the first guide under a state in which the opening and closing portion closes the opened and closed portion.

### Ninth Aspect

In a ninth aspect, the sheet conveying device according to any one of the first to eighth aspects further includes a support shaft and a reinforcement. The opening and closing portion is configured to be rotatable about the support shaft together with the second guide with respect to the opened and closed portion. The reinforcement reinforces the strength of the opening and closing portion is disposed in a region closer to the support shaft than a position at which the feeler is disposed.

### Tenth Aspect

In a tenth aspect, an image forming apparatus includes the sheet conveying device according to any one of the first to ninth aspects. The opened and closed portion is the body of the image forming apparatus including a body side guide as the first guide. The opening and closing portion is an opening and closing cover rotating about the support shaft together with a cover side guide as the second guide with respect to the body of the image forming apparatus.

### Eleventh Aspect

In an eleventh aspect, the image forming apparatus according to the tenth aspect includes a fixing device that is exposed under a state in which the opening and closing cover is opened.

### Twelfth Aspect

In a twelfth aspect, a sheet processing apparatus that performs post-processing or pre-processing on a sheet on which an image is formed by an image forming apparatus includes the sheet conveying device according to any one of the first to ninth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A sheet conveying device comprising:
a body;
a first guide in the body;
a cover to open and close the body to expose at least a part of the first guide at an opened state of the cover;
a second guide in the cover, the second guide facing the first guide to form a sheet conveyance path at a closed state of the cover;
a detector to detect a sheet passing through the sheet conveyance path, the detector including:
a feeler in the cover and movable relative to the second guide, the feeler including:
a detected portion movable in conjunction with the sheet passing through the sheet conveyance path; and
a contacted portion attached to the detected portion; and
a photosensor in the body, the photosensor having a detection region in which the detected portion entering the detection region is detected by the photosensor; and
a positioner in the body to contact the contacted portion to position the detected portion in the detection region when the sheet is not in the sheet conveyance path.

2. The sheet conveying device according to claim 1,
wherein the photosensor and the positioner are disposed at the first guide.

3. The sheet conveying device according to claim 1,
wherein the photosensor and the positioner are formed as a single component.

4. The sheet conveying device according to claim 1,
wherein a rotatable angle of the feeler at the closed state of the cover is smaller than a rotatable angle of the feeler at the opened state of the cover.

5. The sheet conveying device according to claim 1,
wherein the feeler includes another contacted portion, and
the second guide includes another positioner contacting said another contacted portion to position the feeler with respect to the second guide at the opened state of the cover.

6. The sheet conveying device according to claim 1,
wherein the feeler includes:
a rotation shaft connected to the detected portion via another contacted portion; and
a lever projecting from the rotation shaft toward the sheet conveyance path to contact the sheet passing through the sheet conveyance path,
the detected portion and the lever are rotatable about the rotation shaft,
the detected portion is separated from the lever and the rotation shaft by said another contacted portion, and
the contacted portion is farther from the rotation shaft than the detected portion.

7. The sheet conveying device according to claim 1, further comprising a spring in the second guide to bias the feeler against the positioner.

8. The sheet conveying device according to claim 1,
wherein the first guide has an engaged portion, and
the second guide has an engaging portion engaging with the engaged portion, and
the engaging portion positions the second guide with respect to the first guide in a direction:
orthogonal to a direction in which the sheet passes through the sheet conveyance path; and
parallel to a surface of the sheet.

9. The sheet conveying device according to claim 1, further comprising
a support shaft disposed in the body and rotatably supporting the cover; and
a reinforcement in the cover,
wherein the reinforcement is closer to the support shaft than to the feeler.

10. An image forming apparatus comprising
the sheet conveying device according to claim 1.

11. The image forming apparatus according to claim 10, further comprising
a fixing device exposed by opening the cover.

12. A sheet processing apparatus comprising
the sheet conveying device according to claim 1.
